(19) United States
(12) Patent Application Publication
(10) Pub. No.: US 2026/0298394 A1
(43) Pub. Date: Oct. 1, 2026

(54) CLASS 1 FLEXIBLE UNINSULATED DUCT WITH POLYMER CORE AND INTEGRATED FLAME RESISTANT BARRIER LAYER, METHOD OF USE, AND METHOD OF MAKING

(71) Applicant: FLEXIBLE TECHNOLOGIES, INC., Abbeville, SC (US)

(72) Inventors: Ronald L. CARLAY, II, Laurens, SC (US); Hunter FARR, Aiken, SC (US); Luis E. ZULUETA, Saluda, SC (US)

(73) Assignee: FLEXIBLE TECHNOLOGIES, INC., Abbeville, SC (US)

(21) Appl. No.: 19/482,911

(22) PCT Filed: May 13, 2024
(86) PCT No.: PCT/US2024/029033

§ 371 Date: Nov. 10, 2025

Related U.S. Application Data
(60) Provisional application No. 63/466,003, filed on May 12, 2023.

(51) Int. Cl. F16L 57/04; F16L 11/112; F24F 13/02

(52) U.S. Cl. CPC F16L 57/04; F16L 11/112; F24F 13/0218

(57) ABSTRACT

A flexible uninsulated duct that meets Underwriter Laboratories (UL) 181 Class 1 duct standard includes a flame-resistant barrier material-containing single film or a flame-resistant barrier material-containing two film laminate, a polymer film, and a helical wire disposed between the single film or the two film laminate and the polymer film. The single film or the two film laminate, polymer film, and helical wire are attached together to form a duct wall of the flexible duct. The flame resistant barrier material as part of the duct construction provides the necessary properties and performance so that the testing requirements to meet the UL 181 Class 1 air duct standard are met. The flexible duct can be used for moving conditioned or unconditioned air in an interior space of a structure.

### FIELD OF THE INVENTION

The invention relates to flexible uninsulated ducts that carry a UL 181 Class 1 air duct rating, the uninsulated ducts designed primarily for use in interior wall and floor spaces where duct insulating properties are not needed but flame spreading and smoke development resistance for the uninsulated ducts is required.

### BACKGROUND ART

The use of smaller diameter flexible uninsulated ducts for interior spaces like floors and walls in a structure is well known. An example of such a duct is the S-TL duct sold by Flexible Technologies, see https://thermaflex.net/products/thermaflex-s-tl-flexible-duct/. This prior art duct uses a fiberglass cloth fabric bonded to a wire helix to provide its UL 181 Class 1 air duct rating.

Reference to a Class 1 duct rating refers to the UL 181 standard published Jul. 25, 2013 and entitled UL Standard for Safety Factory-Made Air Ducts and Connectors. This standard describes a Class 1 rating as air ducts and air connectors and sets forth a number of tests that must be passed to be entitled to the Class 1 air duct rating, results of these tests including having a flame-spread index of not over 25 without evidence of continued progressive combustion and a smoke-developed index of not over 50. Hereinafter, this standard is abbreviated as the UL 181 Class 1 air duct standard. While both air ducts and air connectors can be rated as Class 1, only products listed as air ducts may be installed within structures in unlimited lengths. North American building code restrictions limit air connectors to 14 feet installed lengths. Air ducts, in order to be listed as such, must meet additional test requirements under UL 181—flame penetration, puncture and impact testing-with flame penetration representing the most stringent. These tests are not required to get an air connector listing.

Although the prior art S-TL duct provides the desired Class 1 air duct rating that permits its use in interior spaces, its manufacturing process is complicated and expensive.

Furthermore, the demand for these kinds of duct applications have grown due to the use of different modes of cooling and heating for interior spaces of structures, wherein ductwork is more often utilized in a conditioned space such that the ductwork is not in need of additional insulation. As such, a need exists to provide an alternative to the prior art duct mentioned above, the alternative duct being one that is more economically made and can better meet the increased demand for these kinds of ducts. Products listed as air connectors are impractical for use in most HVAC applications as the distances required for conveying conditioned air are often in excess of 14 feet. The alternative duct must be listed as an air duct-not an air connector-in order to meet the increased demand.

In response to this need, the inventive duct provides an improved design that facilitates its manufacture in a cost-effective manner while at the same time still providing the Class 1 air duct rating to allow its use in application where this rating is required, for example, as a replacement duct for the S-TL ductwork described above.

### SUMMARY OF THE INVENTION

The invention provides an improvement in flexible uninsulated ducts that meet the UL 181 Class 1 air duct standard.

In one embodiment, the flexible uninsulated duct that meets Underwriter Laboratories (UL) 181 Class 1 air duct standard has a polymer core that includes a helical wire as a part thereof, the polymer core forming an inner space for conditioned air flow. In one embodiment, the polymer core includes a two film laminate that has a flame resistant barrier material integrated therein, the flame resistant barrier material providing the necessary flame penetration resistance, puncture, and impact resistance to allow the flexible duct to have a UL 181 Class 1 air duct rating. The flame spread and smoke developed are measured by the Surface Burning Characteristics test-commonly called the tunnel test. Both ducts and connectors are subject to this test. However, the flame-resistant barrier material is present in order to pass the flame penetration test and puncture test of the standard, which the connectors are not required to pass.

More particularly, the flexible uninsulated duct that meets Underwriter Laboratories (UL) 181 Class 1 air duct standard includes the two film laminate, a polymer film, and a helical wire disposed between the two film laminate and the polymer film, the two film laminate, polymer film, and helical wire attached together to form a duct wall of the flexible duct. The two film laminate further comprises first and second polymer films, a flame-resistant barrier material positioned between the first and second polymer films, and an adhesive to join the first and second polymer films and flame resistant barrier material together, the flexible uninsulated air duct meeting the testing requirements set forth in the UL 181 Class 1 air duct standard.

The polymer film and first and second polymer films of the two film laminate can be made of any polymer material but a polyethylene terephthalate is preferred. The two film laminate can be either an outer layer or an inner layer of the flexible uninsulated duct.

While the adhesive can be any kind that would join the first and second polymer films and flame resistant barrier material together and the two film laminate to the other polymer film. The adhesive is also the kind that also allows the duct with its polymer films and flame resistant barrier material to pass the UL 181 Class 1 duct standards when these standards must be met, including the flame penetration test and high temperature test. The adhesive can be an anaerobic adhesive like an aqueous based pressure sensitive adhesive, an acrylic-based adhesive, or a urethane-based adhesive. In the embodiment discussed above as well as other embodiments of the invention discussed below, it should be understood that one or more adhesives could be employed when making the inventive duct using the flame resistant barrier material.

The flame resistant barrier material can be selected from the group including a woven or nonwoven fabric material containing fiberglass, and a flame resistant fleece, the flame resistant fleece including flame resistant staple fibers and, optionally, char scaffold fibers.

The two film laminate construction can be such that flame resistant barrier material of the laminated film has opposing longitudinal edges and the opposing longitudinal edges are aligned with or spaced inwardly of longitudinal edges of the first and second polymer films.

Another embodiment of the invention is a flexible uninsulated duct that meets Underwriter Laboratories (UL) 181 Class 1 air duct standard and is of slightly different construction as compared to the laminated film-containing flexible duct described above. This embodiment uses only two films as opposed to the three films used in the two film laminate-containing duct. That is, the flexible uninsulated duct includes a first polymer film, a second polymer film, the flame resistant barrier material, and the helical wire. The helical wire is disposed between one of the first and second polymer films and the flame resistant barrier material. The first and second polymer films, the helical wire, and the flame resistant barrier material are attached together using at least one adhesive to form a duct wall of the flexible duct, the flame resistant barrier material providing the same kind of flame penetration and puncture resistance as two film laminate-containing duct such that the flexible uninsulated duct meets the UL 181 Class 1 air duct standard.

As part of this embodiment, one of the polymer films and the flame resistant barrier material can be made into a single film laminate, and this single film laminate can be used like the two film laminate to make a flexible air duct. In this embodiment, the kind of adhesive or adhesives used to make the two film laminate can be used to make the one film laminate and then the typical adhesive used for making flexible ducts can be employed to attach the single film laminate to the helical wire and other polymer film.

The helical wire can be between an inside surface of the duct and the flame-resistant barrier material or the flame resistant barrier material can be between an inside surface of the duct and the helical wire.

The invention also entails a method of moving conditioned or unconditioned air through a flexible uninsulated duct in an interior space of a structure, wherein the flexible uninsulated duct meets the UL 181 Class 1 air duct standard, the improvement comprising providing one or more of the flexible uninsulated ducts described above in the interior space. The one or more flexible uninsulated duct can be positioned in a wall or floor space as the interior space in the structure.

The invention also includes the single or two film laminate alone for use in a flexible uninsulated duct. Either of these laminates can come from a master roll that has the features of the laminates but is wider than the laminate final size for duct making. The master roll can be cut down in width to produce roll segments of the desired size for duct making. The cut or slit edges are believed to have a higher integrity bond as compared to edges of the master roll as there are no free longitudinal edges of the flame resistant barrier materials that are part of the slit edges of the roll segments derived from the master roll.

The invention is also an improvement in a method of making a flexible uninsulated duct. The prior art method includes winding first and second polymer films and a helical wire disposed therebetween and applying an adhesive onto one or both of the polymer films to join the first and second polymer films and helical wire to make a duct wall. The improvement to this kind of duct is the use of either of the laminates of the invention, single film or two film laminate, as either the first or second polymer film such that the flame-resistant barrier material of the laminate provides flame penetration and impact resistance such that the flexible uninsulated duct meets all of the testing requirements for the UL 181 Class 1 air duct standard.

Another improvement of the invention relates to the same prior art method of making a flexible uninsulated duct by winding first and second polymer films and a helical wire disposed therebetween and applying an adhesive onto one or both of the polymer films to join the first and second polymer films and helical wire to make a duct wall. In this improvement, the flame-resistant barrier material is disposed between one of the first and second polymer films and helical wire using the adhesive to form the flexible uninsulated duct, the flame-resistant barrier material of the laminated film providing flame penetration and impact resistance such that the flexible uninsulated duct meets the UL 181 Class 1 air duct standard. In this method, the helical wire can be between an inside surface of the duct and the flame-resistant barrier material or the flame resistant barrier material is between an inside surface of the duct and the helical wire. This improvement also corresponds to using the single film laminate, which combines one of the two polymer films with the fire resistant barrier material prior to making the duct with the other polymer film and helical wire.

When making the single film or two film laminate, one or both of the films could be perforated to speed up the drying time if the kind of adhesive that requires drying as part of adhesion is used to attach the flame resistant barrier material to either one or both of the polymer films. The invention also entails the use of one or more of the flexible uninsulated ducts for moving conditioned or unconditioned air therethrough in a given structure, wherein the one or more flexible uninsulated ducts is in an interior space of a structure, e.g., in floor or walls spaces of the structure, wherein further insulation for the inventive duct is not required.

Another embodiment of the invention is the use of a coated flame resistant barrier material in place of the single film or two film laminate for duct construction. This coated flame resistant barrier material can come in a master roll like the laminates, can be adhered to the helical wire and other polymer film to make the duct, can be on the inside or outside of the duct, and still provide the performance to meet the UL 181 Class 1 air duct standard. The same method of using and making the laminates can be employed when using the coated flame resistant barrier material as a component part of the duct.

While the flame resistant barrier material can be coated just on one side, preferably, the flame resistant barrier material is coated on both sides with the coating also penetrating the flame resistant barrier material. The coating is preferably a water-based acrylic coating that contains fire retardants, the fire retardants assisting in controlling any unwanted ignition of the coating when the duct is subjected to testing using the UL 181 Class 1 duct standards, particularly flame penetration testing.

The coated flame resistant barrier material embodiment can also be employed in a spiral wound duct making process similar to those described above for other embodiments of the inventive duct, wherein instead of making a duct using the double film laminate in combination with the helical wire, polymer film and adhesive(s), the coated flame resistant barrier material is spiral wound with the helical wire, adhesive(s), and polymer film to form the inventive duct.

### BRIEF DESCRIPTION OF THE DRAWINGS

FIG. 1 shows a portion of the inventive flexible duct in perspective view.

FIG. 2 shows a longitudinal cross sectional view of a two film laminate of the duct of FIG. 1.

FIG. 3A shows a perspective view of the two film laminate in strip form.

FIG. 3B shows a transverse cross sectional view along the line B-B of FIG. 3A.

FIG. 4A shows a transverse cross sectional view of another embodiment of the two film laminate component of the inventive flexible duct.

FIG. 4B shows the same view of FIG. 4A with the laminated layer slit into multiple pieces.

FIG. 5 shows a longitudinal cross sectional view of a portion of the flexible duct of the invention of the flame resistant barrier material of the inventive duct in connection with duct manufacture.

FIG. 6A shows an enlarged view of a longitudinal portion of the inventive duct between portions of the flexible duct containing the helical wire.

FIG. 6B shows an alternative arrangement of the inventive duct components as compared to FIG. 6A.

FIG. 7 is a longitudinal schematic cross sectional view of another embodiment of the inventive flexible duct with two polymer films, the flame resistant barrier material, and a helical wire.

FIG. 8 shows a variation on the embodiment of FIG. 7, wherein the flame resistant barrier material and helical wire are switched in position.

FIG. 9 shows another embodiment of the invention, wherein a single film laminate is made as opposed to the two film laminate of FIG. 2.

FIG. 10 shows a schematic of the overlap part of the duct according to the embodiment of FIG. 7.

FIG. 11 shows a schematic of a duct construction using a coated flame resistant barrier material instead of the single film or two film embodiments of the inventive duct.

FIG. 12 shows a schematic of a duct construction using a coated flame resistant barrier material as shown in FIG. 11 but with coating on one side of the flame resistant barrier material.

### DETAILED DESCRIPTION OF THE INVENTION

The flexible uninsulated duct provides significant advantages over other and similar type ducts. Whereas the entire duct construction of the prior art duct S-TL is designed to meet the UL 181 Class 1 air duct standard, the inventive flexible uninsulated duct can be more economically made due to the ability to use the well known technology of making a stock polymer core.

In the inventive flexible duct, the polymer core differs from the prior art polymer core in a significant manner. The prior art polymer core is typically made from two films of a polymer material, usually polyethylene terephthalate (PET), with a helical wire being disposed between the two films. The films are adhered together using an adhesive to form the prior art polymer core. As this kind of a core is well known, a further description of it is not needed for understanding of the invention.

In one embodiment, the invention differs from this construction by having one of the two films comprise a two film laminate that includes a flame resistant barrier material as an integral layer that is a part thereof. The two film laminate has a sandwich construction, wherein the flame resistant barrier material is disposed between two polymer films. The manner in which this two film laminate is made is described in more detail below. This two film laminate can be the outer or inner component of the flexible duct as the two film laminate provides the necessary strength and flame resistant properties to allow the flexible duct to meet the requirements imposed by UL 181 Factory Made Air Ducts and Air Connectors standard, 11^{th} edition, which is herein incorporated by reference.

As part of the air duct construction, the two film laminate is combined with another polymer film and helical wire that are part of the conventional flexible duct to form the inventive flexible duct. Again, the two film laminate can be the outer layer of the flexible duct and the other polymer film can be the inner layer of the duct, with the helical wire disposed therebetween. Alternatively, the two film laminate can be the inner layer of the flexible duct and the other polymer layer could be the outer layer.

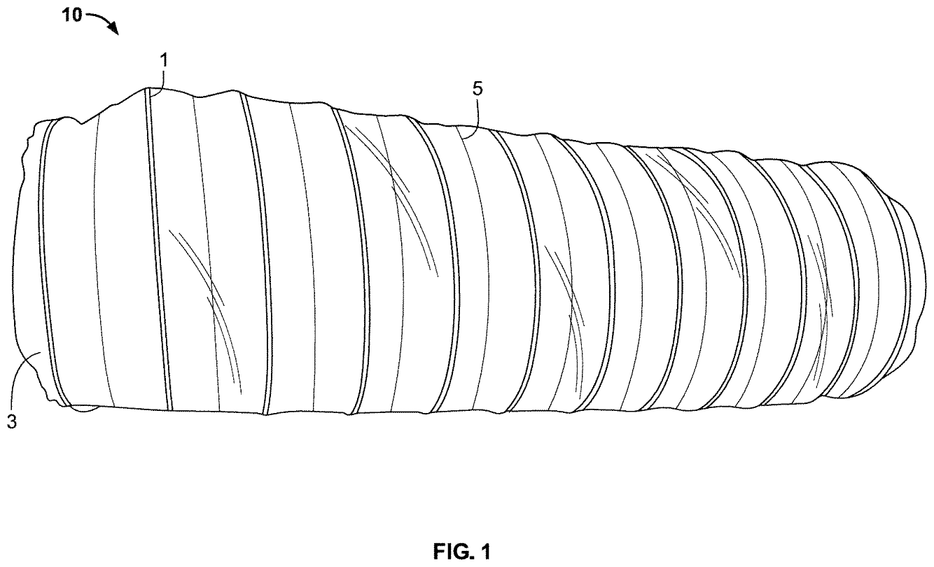

FIG. 1 shows a perspective view of the inventive flexible duct, which is designated by the reference numeral 10. The helical wire is designated by the reference numeral 1 and the duct core material is designated by the reference numeral 3. When making these kind of flexible air ducts, strip/tape that correspond to the inner and outer duct layers and the helical wire are continuously wound on a mandrel (including the application of the appropriate adhesive) to join the inner and outer tapes and helical wire together to manufacture the duct in a continuous fashion. With this mode of manufacturing, there is overlap of the wound polymer core strip materials and this overlap is signified by reference numeral 5. The frequency of the overlap along the length of the air duct is a function of the size of the strips used to make the air duct and the pitch of the mandrel or amount of twist in the mandrel. The single overlap shown between the helical wires 1 is only exemplary and more than one overlap could occur between adjacent wires, depending on the pitch of the strips being wrapped around the mandrel.

In one mode of making the inventive duct, the two film laminate having the flame resistant barrier material as a part thereof is formed and this two film laminate is then used with a polymer film and helical wire to make the duct 10. In another mode, it would also be possible to automate the entire duct making process, wherein two film laminate is made as part of combining the other polymer film and the helical wire in duct manufacture.

In a further embodiment of the invention, the flame resistant barrier material is interposed between two polymer films, with the helical wire disposed between one of the polymer films and the flame resistant barrier material.

In yet another embodiment of the invention, a single film laminate of one polymer film and the flame resistant barrier material can be made. Then, the helical wire is disposed between this single film laminate and the other polymer film to make the air duct. These embodiments are discussed in more detail below.

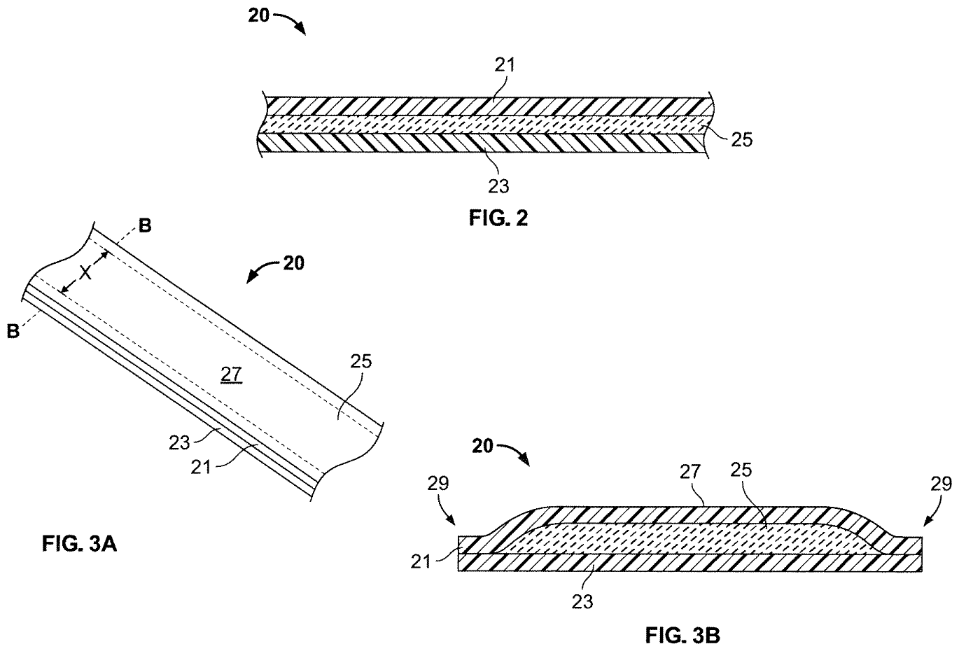

FIG. 2 shows a schematic drawing of a longitudinal cross sectional view of a part of the flexible uninsulated duct 10, i.e., a two film laminate. The two film laminate 20 includes first and second films 21 and 23. These first and second films could be any that are used to make the kind of flexible ducts related to the invention. Preferably, the material is PET but the films are not limited to this material construction. Disposed between the first and second films 21 and 23 is a flame resistant barrier material 25. The make-up of the flame-resistant barrier material 25 is detailed below and is of the type that when incorporated as part of the two film laminate 20, the two film laminate then incorporated as part of the duct material 3, the duct 10 would meet the UL 181 standards and be classified as a Class 1 air duct.

FIG. 3A show the two film laminate 20 of FIG. 2 as a strip of film of defined width in perspective view with the flame resistant barrier material 25 having a width designated by “X.” FIG. 3B shows a transverse cross-sectional view along the line B-B of FIG. 3A. In this embodiment, the width X of the flame resistant barrier material is less than the width of the first and second films 21 and 23, such that side edges of the flame resistant barrier material 25 would be spaced from the side ends of the first and second films 21 and 23 as shown in FIG. 2. Having the spacing from the edges of the two film laminate 20 allows for a complete encapsulation of the flame resistant barrier material 25 by the first and second films 21 and 23. This encapsulation prevents any exposure of the flame resistant barrier material and any potential compromise in performance of the duct when the two film laminate is used to form the flexible duct by joining with another polymer film and the helical wire.

Still referring to FIG. 3B, because the flame resistant barrier material 25 has a finite thickness and is disposed between the first and second films 21 and 23, the outer layer surface 27 of the two film laminate 20 is not planar at outer longitudinal edge portions 29 of the two film laminate 20. As detailed below, these outer edge portions 29 involve areas of overlap of the two film laminate 20. These overlap areas are important in terms of their properties as the overlap 5, see FIG. 1, is positioned between the helical wire 1 and this overlap area is one area that is involved in testing to meet the UL 181 standards as is discussed in more detail below.

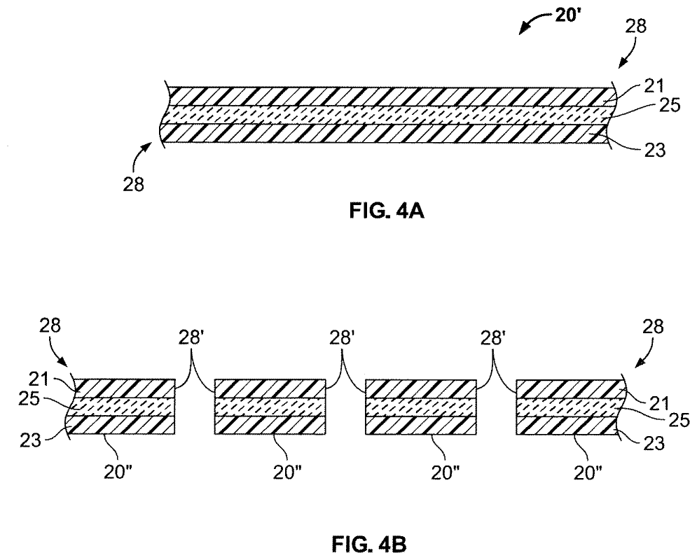

FIG. 4A shows a transverse cross section of another embodiment of the two film laminate film of the invention designated as 20′. In this embodiment, the flame resistant barrier material 25 is sized so that its width matches that of the two polymer films 21 and 23, thus, the outer longitudinal edge portion 29 does not have the bump as shown in FIG. 3B. While there may be some exposed material of flame resistant barrier material in this embodiment at the longitudinal edges 28 of the strip 20′, this exposure could be minimized in the way the two film laminate could be made as is detailed below.

The manner in which the two film laminate 20 is made can be any type. The two film laminate could be made in a continuous fashion wherein the first and second films and flame resistant barrier material are made in the form of a tape or strip. The strips of each of the first and second layers and strip of the flame resistant barrier material can then be continuously joined together with the appropriate adhesive disposed to make the two film laminate in its final size for air duct manufacture. Prior art flexible air ducts made of PET films interposed with an adhesive, e.g., a pressure sensitive adhesive, and the helical wire are commonly made in a continuous manner and this prior art technique could be adapted for use with the first and second films, flame resistant barrier material, and adhesive.

Alternatively, finite lengths of the first and second films and the flame resistant barrier material, along with an adhesive could be used for joining, which would be more of a batch-type process.

In yet another mode, the flame resistant barrier material 25 could be first adhered to one of the first and second films 21 and 23. Once this two-material composite or laminate is produced, the other of the first and second films 21 and 23 could be adhered to the composite or laminate of flame resistant barrier material and the one film in order to form the final three-main material composite or two film laminate.

It is important that a secure bond is created for the two film laminate 20 so that the flame-resistant barrier material is intact and can provide the require flame resistance properties so that the flexible duct can meet the testing standards to achieve a UL 181 Class 1 duct rating. The secure bond is also essential in preventing delamination of the laminate layers and/or the laminate from the polymer film in order to achieve the necessary pressure rating and meet the tension test requirements for the UL 181 Class 1 air duct rating

When using a woven material as the flame resistant barrier material, when the woven material is cut longitudinally, the weave can come undone and the woven material could break down at the cut or slit edge. When making the two film laminate having the configuration shown in FIG. 4A for flexible duct manufacture, there may be a risk that the edges of the flame resistant barrier material are not fully adhered to the polymer films at the edges 28 of the strip 20′. In addition, if the flame resistant material is cut at the edges 28 shown in FIG. 4A, the weave of the material can come undone and cause further problems in terms of the integrity of the duct.

To address this potential problem in one way, the two film laminate 20 could have a larger width than that used to make the flexible duct. In this instance, a wide flame resistant barrier material could be paired with wide polymer films so that a wide two film laminate could be made as a master roll. This wide two film laminate could then be resized to a width that would be used to make the flexible duct.

One example of the resizing would be to make a two film laminate that is 60 inches wide and then slit the 60 inch wide film to the desired size for flexible duct making. By making the two film laminate wider and then slitting it to size, the slit edges of the flame resistant barrier material would be derived from the interior of the wide two film laminate and the flame resistant barrier material would be fully adhered between the two polymer films as a result of laminating the wide materials together. As such, there would be less risk once the two film laminate is cut to size so that the longitudinal edges of the flame-resistant barrier material in the two film laminate would come undone and compromise the integrity of the laminated layer.

As an example of cutting down a wide two film laminate, a strip 60 inches wide of a two film laminate could be slit into four sections, see FIG. 4B, and four strips 20″ would be created for use in making the flexible air duct 10. In this embodiment, the slit edges 28′ would be of a different nature from the edges 28 as the joining of the layers 60 at the longitudinal and exposed edges of the strip 20′ may not be as complete as the joining that occurs between the layers 21 and 23 and flame resistant barrier material 25 for portions of the strip 20′ inward of the edges 28. Thus, the use of strips with longitudinal edges that are formed by slitting a wide two film laminate may have a better performance in meeting the UL 181 Class 1 duct standards when used to make the flexible air duct 10. As another option, the edges 28 of the original wide two strip laminate 20 could be cut off so that each slit section would have the joined edges 28′.

It should be understood that a width of 60 inches as a starting material for cutting or slitting and 15 inch slit strips is only an example of starting widths and cut widths for the invention. More than 3 cuts could be made on a 60 inch wide strip to accommodate the desired cut strip width. Typically, a flexible polymer air duct is made using 2 inch wide strips so that a 60 inch master roll could generate 30 2 inch strips for duct making. From a cost perspective, making the two film laminate film and the flexible duct using a wider flame resistant barrier material and wider polymer films is more economically attractive as a 60 inch wide woven material could be used as the starting material instead of starting with much narrower material that would be more expensive.

Although not illustrated in FIGS. 2 and 3, at least one adhesive would be used to join together the first and second films 21 and 23 and the flame-resistant barrier material 25 together. Any adhesive or combination of adhesives could be employed that would stand up to the Class 1 duct testing regimen as detailed below. One example of an adhesive used in duct making is an acrylic based adhesive. While ethylene vinyl acetate adhesives could be employed as well when making the two film laminate, the acrylic based adhesives are less brittle and more conducive to flexible air duct making processes. Another example of an adhesive is a urethane based adhesive.

The application of the adhesive can vary depending on the kind of flame resistant barrier material that is employed as the layer 25. If the barrier material has sufficient porosity, application of the adhesive between one of the first and second films 21 and 23 and the flame resistant barrier material 25 may provide sufficient joining as the adhesive could penetrate through the flame resistant barrier material 25 and contact the other of the first and second films for adhesion purposes. Alternatively, the adhesive could be applied so that it is between both of the first and second films and the flame resistant barrier material for adhesion. The flame resistant barrier material should not be too porous though, wherein it would not provide sufficient flame penetration resistance during UL testing.

The type of adhesive used to form the two film laminate also needs to take into account the high temperature testing of the UL 181 duct standard. In this testing, the air duct being tested is exposed to a temperature of 125° F. on the exterior and not less than 265° F. on the interior. The adhesive used to form the two film laminate has to be one that will maintain its adhesive properties during this test so as to maintain the integrity of the two film laminate that is part of the air duct.

The flame-resistant barrier material can be made of any material that would provide the performance to meet UL 181 Class 1 air duct testing requirements, as part of its integration into the two film laminate of the flexible duct 10. The materials of the flame-resistant barrier material include woven and nonwoven materials, including fiberglass-containing materials, materials that use Nomex fibers, materials that use Nomex fibers in combination with other fibers, materials that may contain ceramic coated fibers/yarns, and the like.

One example of the material that can be used as the flame resistant barrier material is a flame resistant fleece as disclosed in U.S. Pat. No. 10,443,190 to Wenstrup, which is incorporated in its entirety herein. This fleece includes a flame resistant (FR) fiber, which is defined to be fibers having a limiting oxygen index (LOI) value of 20.95 or greater as determined by ISO 4589-1. The Wenstrup patent provides different examples of these kinds of fibers, e.g., FR resistant rayon staple fibers wherein these fibers are between 20-80% of the weight of the fleece. The fleece also preferably includes a plurality of char scaffold fibers, which are defined as fibers once burned retaining a portion (at least 80%) of their original strength. Examples of these include mineral fibers such as silica and basalt, aramids, carbon fibers, partially oxidized polyacrylonitride (PAN) and fully carbonized fibers, with the weight percentage of these preferable fibers similar to the FR fibers, i.e., between 20-80% by weight. The flame resistant fleece can also incorporate a scrim as a part thereof and include other non-flame resistant fibers, e.g., polyester fibers, up to a certain weight percentage that does not comprise the flame resistant properties of the fleece.

It is also believed that the fiberglass fabric used in the S-TL duct described above is also a candidate for the flame resistant barrier material of the inventive duct. High-Temp Suntex textiles also provide a number of different materials, e.g., flame resistant fiberglass fabric, high temperature fiberglass cloths, and woven fiberglass cloths that are believed to be suitable candidates as the flame resistant barrier material of the inventive duct, see https://www.coatedfiberglassfabric.com/supplier-307158-fire-resistant-fiberglass-fabric, https://www.coatedfiberglassfabric.com/supplier-305933-high-temperature-fiberglass-cloth, and https://www.coatedfiberglassfabric.com/supplier-305861-woven-fiberglass-cloth.

Fiberglast also makes woven and nonwoven fiberglass fabrics that are believed to be suitable for use as the flame resistant barrier material, see https://www.fibreglast.com. Fiberglass-containing fabrics made by Milliken & Co. of Spartanburg, South Carolina are also candidates for the flame resistant barrier material.

While the flame-resistant barrier material can be any type of material that, when integrated into the flexible duct would meet the UL 181 Class 1 duct standard, a preferred material would be a woven or non-woven fabric material containing fiberglass. An alternative material would be a flame resistant fleece comprising flame resistant staple fibers and optionally char scaffold fibers.

One key to the invention is the use of the flame-resistant barrier material as an integral part of the one of the inner and outer layers of the uninsulated flexible air duct. While the polymers making up the inner and outer layers of the air duct by themselves would not stand up to the flame penetration test of the UL 181 air duct standard, integrating the flame resistant barrier material into the one of the layers of the duct as a laminate film or integrating the flame resistant barrier material into the two film and helical wire arrangement would prevent the occurrences of perforations in the flexible duct that would allow the direct passage of flame or gases through the duct or ignition occurring on the surface of the duct being tested, such ignition exterior to the combustion zone of the test apparatus.

As noted above, the two film laminate 20 having the flame resistant barrier material 25 as a part thereof is combined with another polymer film and the helical wire to make the flexible duct. These two layers, i.e., the two film laminate 20 and the other polymer film, are preferably combined in the same fashion that two PET films, helical wire, and an adhesive are combined to make the prior art flexible polymer duct, but other alternative ways of making the duct are detailed below.

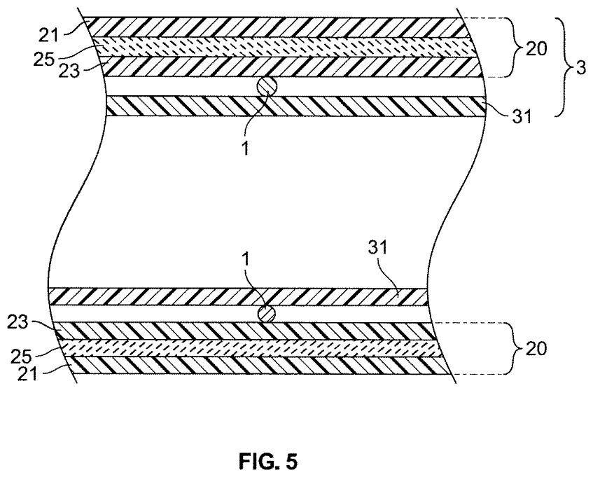

Referring now to FIG. 5, a schematic longitudinal cross section of the duct material 3 is shown including the helical wire 1 with the two film laminate 20 being the outer duct layer in this embodiment. The helical wire 1 is interposed between the two film laminate 20 and an inner film 31 so that the two films 20 and 31 essentially form the wall of the flexible air duct, with the helical wire spiraling along the air duct and positioned between the two films 20, 31 length to provide support and flexibility for the air duct 10.

As is known in the art, the two film laminate 20 and inner film 31 are joined using an adhesive in the same manner as would be used when making the prior art flexible air ducts mentioned above. Instead of using two PET layers and adhering them together with the helical wire interposed therebetween as is conventionally done, the two film laminate having the flame resistant barrier material is substituted for the one of the films used in the conventional helical wire-containing flexible ducts.

Instead of making the two film laminate 20 first and then making the flexible air duct 10 second, the making of the two film laminate and the flexible air duct could be combined as one continuous process. That is, the film 31, helical wire 1, the first and second films 21 and 23 and the flame resistant barrier material 25, and the necessary adhesive(s), could be manipulated in a single continuous process to make the flexible duct 10 rather than making the two film laminate 20 separately and then combining it with the helical wire 1 and film 31 to form the flexible duct.

It should be understood that the adhesive used as part of the two film laminate 20 is not depicted in FIG. 5. As described above, it could be a part of the flame-resistant barrier material 25 by diffusion into the material 25 and/or as being a distinct layer between the material 25 and either or both of the first and second films 21 and 23.

Similarly, the adhesive used to join the inner film 31 and two film laminate 20 together and incorporate the helical wire therebetween is also not depicted in FIG. 5 for clarity purposes. It is believed that the adhesive that is typically used when making the conventional prior art flexible duct using two films of polymer material and a helical wire would be sufficient for purposes of joining the two film laminate 20 and the film 31 together with the helical wire. However, other higher strength adhesives, e.g., a urethane-type adhesive, could be used to ensure that the overlap shown in FIG. 1 does not compromise the strength or integrity of the flexible duct 10 when being subjected to the various tests under the UL 181 Class 1 air duct standard.

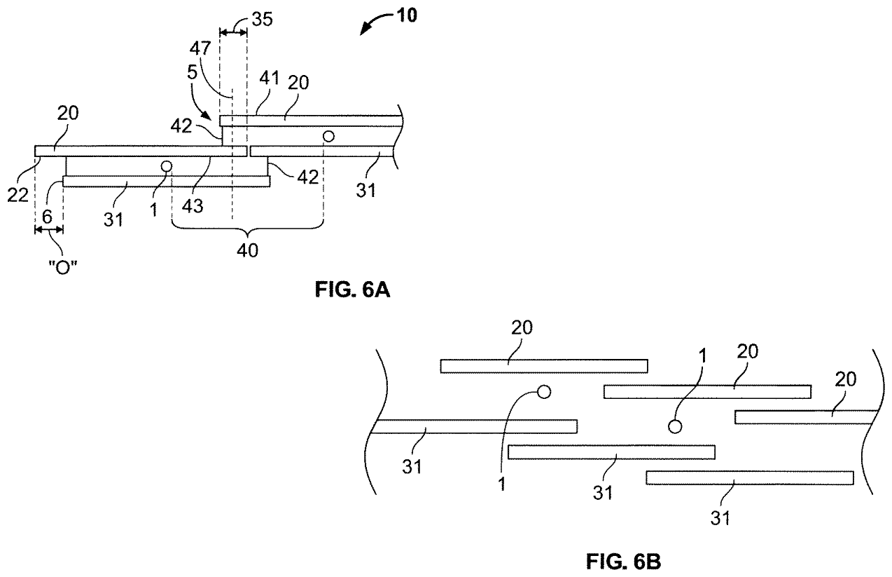

FIG. 6A shows an enlarged schematic illustration of a longitudinal portion of wall of the flexible duct 10 showing how the two film laminate 20 as the outer layer of the duct, the inner polymer layer 31 and helical wire are arranged in space. Typically, there is an offset between the two film laminate 20 and polymer film 31 when wound on a mandrel, e.g., ¼-½ inch, the offset designated by “O” in FIG. 6A. In making the duct 10, an adhesive is applied to the surface 22 of the two film laminate 20, typically 2 inches wide. The two film laminate 20 is wrapped around the mandrel, and at the same time, the polymer film 31 of the same width as the two film laminate, just offset, and helical wire are interposed between the mandrel and the adhesive-containing surface 22 of the two film laminate laminated film 20 during the winding process. The two film laminate 20 and the film 31 are thus joined together with the helical wire positioned therebetween. In a 25 foot duct, the films would wrap around the mandrel about 300 times.

In FIG. 6A, the overlap 5 from FIG. 1 is seen on the outside of the duct. Although not apparent from FIG. 1, there is also an overlap 6 on the inside of the duct. On the outside of the duct 10, the overlap 5 is between the outer laminate films 20 and the inside of the duct has an overlap of the inner films 31. The overlap for the two film laminate is designated by reference numeral 35.

As can be seen from FIG. 6A, the overlap 5 exposes the longitudinal edge of the two film laminate 20. Thus, this edge must be adequately sealed, either by employing the embodiment of FIG. 3B, wherein there is overlap of the films 21 and 23 or a construction of the laminate film 20′ that provides an edge where the bond between the film edges and edge of the flame resistant barrier material seals the materials together so that no openings or voids exist that would allow air entry of disruption of the laminate and comprise the integrity of the duct for testing under the UL 181 Class 1 air duct standard.

Another aspect of the invention is the extent of the overlap when considering the added flame resistant barrier material to the duct construction. Since the films 20 and 31 would wrap around a mandrel approximately 300 times, the smaller the overlap, the less flame-resistant barrier material would be used for duct making. This section 40 of duct includes both the duct material 3 by itself and overlapped duct material, which is designated by the reference numeral 35. The section 40 of duct shown in FIG. 6A is intended to represent the longitudinal portion of the duct that is between longitudinally adjacent helical wires. This section 40 and the overlap between the films, particularly the flame resistant barrier material-containing film is important in terms of meeting some of the standards that are imposed by the UL 181 Class 1 duct standard.

Still referring to FIG. 6A and the embodiment wherein the flame-resistant barrier material does not extend entirely to the ends of the strips of the first and second films as shown in FIG. 3A, it is important that the extent of the overlap 35 is such that that the flame resistant barrier material in the wall portion 41 overlaps the flame resistant barrier material in the wall portion 43. Should the overlap include a segment of duct wall that is just the first and second films 21 and 23 and the inner layer 31, this segment would be lacking the flame resistant barrier material and could not pass the flame penetration test required for a UL 181 Class 1 air duct rating. That is, during this test, the polymer component of the duct wall as the segment lacking the flame resistant barrier material would burn off and there would be nothing to prevent furnace gases and flames from penetrating the duct. The arrangement of the various films/laminates in FIG. 6A with respect to the helical wire is only exemplary and other arrangements can be employed to make the flexible air duct.

As noted above, an adhesive is used to join the overlapped wall portions of the duct material 3 as part of the duct making process and the adhesive is designated by reference numeral 42 in FIG. 6A. However, in another mode of the invention, the overlapped portion 35 could include some kind of mechanical fastening to enhance the integrity of the overlap. One example would be a stitching wherein the stitching material would be made of a flame resistant barrier material as well. The stitching is represented by the dashed line 47 in FIG. 6A.

One of the tests that involves the duct section 40 of FIG. 6A is the flame penetration test under the UL 181 air duct standard. In this test, a section of duct material, including the helical wires is placed over a furnace and a weight is placed on the inner layer of duct material 3 (the outer layer of the duct faces the furnace during the flame penetration test). The section of the duct wall, i.e., section 40, is the one that receives the weight, this section 40 including the overlap of the duct wall as well as the flame-resistant barrier material in the duct wall 3. Thus, it is important that sufficient overlap between the duct material exists so that the fire-resistant barrier material functions in accordance with its intended purpose. Since the two film laminate 20 includes an overlap, this overlap needs to be sufficiently strong as well to withstand the weight imposition as part of the flame penetration test.

As noted above, the arrangement of the two film laminate, helical wire, and film 31 can vary as part of the duct making process. Some cores are made with bottom overlap of the films 31 under the helical wire 1 and the top overlap of the two wire laminate 20 between the helical wire 1 as shown in FIG. 6B.

As mentioned above, the two film laminate could be used as the inner or outer layer of the flexible duct. If the two film laminate is used as the inner layer, during the flame penetration test that is part of the UL 181 Class 1 air duct standard, the sample of the flexible duct that is used as part of this testing has the outer surface of the flexible duct facing the furnace. In this configuration, the two film laminate, as the inner layer of the flexible duct would be facing away from the furnace and would be supported by the helical wire during the testing procedure (the polymer film as the outer layer would face the furnace and be beneath the helical wire). Such support is believed to enhance the ability of the flexible duct to withstand the weight that is placed on the flexible duct sample during the flame penetration testing. However, it is believed that even if the flame resistant barrier material is used as the outer layer of the flexible duct and it is positioned beneath the helical wire during the flame penetration testing, the flexible duct should still pass the flame penetration testing.

The integrity of the two film laminate as well as the overlap also becomes important for other tests that the UL 181 duct standard requires. One such test is the pressure test, wherein the duct is pressurized 2.5 times the manufacturer's rated positive pressure to determine if leaking would occur or if any damage is caused to the duct during the pressure test. Thus, it is important that the two film laminate and the joining of the first and second films and flame resistant barrier material and the overlap between the duct material is sound so that high pressure would not compromise the two film laminate or duct material overlap in some way. Should the joints not be sound, air could enter into the joints and disrupt the lamination and cause a failure as a result thereof.

Similarly, the tension test part of the UL 181 duct standard can also test the integrity of the two film laminate that is part of the duct construction. In this test, the duct is put in a vertical position and subjected to a 25 pound force over a 24 hour period. Since this test creates some shearing forces for the overlap and the two film laminate joint, it is important that the overlap and/or two film laminate are sufficiently strong to pass the tension test of the UL 181 duct standard.

One measure of testing the integrity of the two film laminate is to test the shear strength of the bond between the first and second films once the two film laminate is formed. An exemplary shear strength range would be 10-25 pound force based on a linear inch of adhered materials, preferably 15-22 pound force per linear inch. For example, for a spiral wound duct, the overlap between windings of the flame resistant barrier material may be an inch in width. As the integrity of this overlap is important when the duct is subjected to UL 181 Class 1 duct standard testing, the bond between the overlapped materials should exhibit a sufficient shear strength in the ranges noted above to ensure the integrity of the overlap for duct testing and use in a given application.

When using a woven fabric, e.g., a fiberglass woven material as the flame resistant barrier material, these materials have different kinds of weaves, e.g., plane weave, satin weave, and jacquard weave. Any of these weaves are believed to provide sufficient strength at the overlap along the duct wall length.

Whereas the embodiment of the invention in FIGS. 1-6B uses a two film laminate 20 and another polymer film 31, which, in essence, uses three polymer films, the helical wire, and the flame resistant barrier material, another embodiment of the invention relates to a flexible duct that is made with a laminate construction using two polymer films, the helical wire, and the flame resistant barrier material.

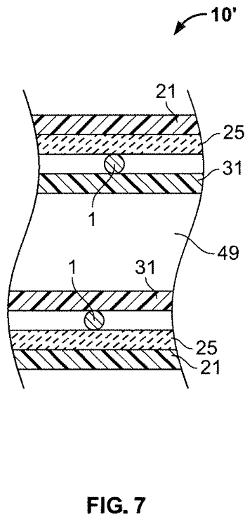

In this embodiment, instead of attaching together the two film laminate 20 and polymer film 31 together, wherein the helical wire is disposed between the two film laminate 20 and the polymer film 31, the flame resistant barrier material and helical wire are laminated between two polymer films to form the duct wall. FIG. 7 shows a longitudinal cross sectional schematic of this type of duct wall construction. This duct is designated as 10′ as it uses the film 21, the fire resistant barrier material 25, the helical wire 1, and the film 31. The adhesive used to join the films, flame resistant barrier material, and helical wire is not shown for clarity. The adhesive could be the same that is used to make the laminate film or an adhesive typically used to adhere the two polymer films in a conventional duct construction. In this embodiment, the flame resistant barrier material is shown on the outer side of the duct, with the helical wire 1 between the flame resistant barrier material and the inside channel 49 of the duct 10′.

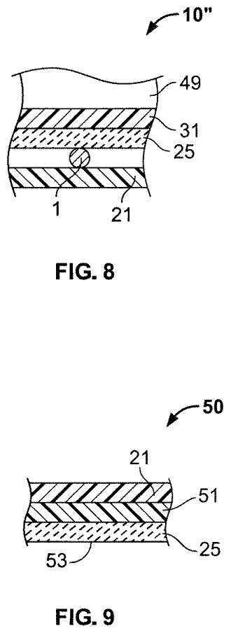

However and as explained above for the embodiment of FIG. 5, wherein the flame resistant barrier material 25 is part of the outer portion of the duct 10, the position of the flame resistant barrier material 25 and helical wire 1 could be switched in FIG. 7. FIG. 8 shows one part of a duct 10″ with this switch employed, wherein the flame resistant barrier material 25 is between the inner film 31 and the helical wire. As detailed above, the outside of the duct 10″ faces the combustion chamber in the flame penetration test. This means that when the duct 10″ is tested in the FIG. 8 embodiment, the film 21 faces the combustion chamber and the helical wire 1 would be positioned beneath flame resistant barrier material 25, thereby offering more support for the flame resistant barrier material during the test. Furthermore, when the flame-resistant barrier material is employed as part of duct wall facing the inside of the duct as in FIG. 8, the thick edge of the coated or laminated flame-resistant barrier material is protected from abrasion and possible mechanical delamination by snagging on sharp edges or corners. This is especially important during the installation process when these types of ducts are pulled through wall cavities and between floors.

Another variation of the embodiment shown in FIGS. 7 and 8 is to first make the single film laminate and use this single film laminate to produce the construction of the duct wall shown in FIGS. 7 and 8. This single film laminate is designated by the reference numeral 50 in FIG. 9. The single film laminate is made up of the film 21, an adhesive layer 51, and the flame resistant barrier material 25. A surface 53 of the flame resistant barrier material 25 would be that intended to bond to the film 31 with the helical wire 1 disposed between the surface 53 and the film 31.

This single film laminate 50 can also be made into a master roll and slit as is described above for the two film laminate 20.

Another difference between the duct using the single film laminate and the embodiment of FIGS. 7 and 8 is that an adhesive is used to join the flame resistant barrier material to the film to form the single film laminate and another adhesive is used as part of making the duct.

Besides the advantages of making a master roll using either the two film or single film laminate as detailed above, employing these pre-made laminates allows more flexibility in duct manufacture. When making a flexible duct, it is typical to use a water based pressure sensitive adhesive that is applied to the desired surface and allowed to dry before duct manufacture as the adhesive is an anaerobic type that bonds without the need for air. When pre-making the laminates, the adhesive could be one that is not necessarily pressure sensitive as there would be available drying time before the pre-made laminate is used in duct making.

Furthermore, when pre-making the single film or two film laminates for duct manufacture, one or both films that make up the laminate could be perforated to some extent to enhance the drying of the adhesive if an adhesive that required drying time were to be used to make the laminate. The perforations would be especially preferred when two films are used as opposed to the single film laminate, wherein the exposed flame resistant barrier material can facilitate drying of the adhesive. Even ethylene vinyl acetate adhesives could be employed as part of laminate making in spite of their required drying time. Such perforations would be more advantageous when making a master roll of the two film laminate using an aerobic adhesive so as to allow air to access the adhesive once the master roll is made. It is believed that perforations up to 50% of the surface area, more preferably up to 20% of the surface area, of one of the films of the two film laminate or the single film laminate could be employed without compromising the integrity of the duct when made with the perforated laminate.

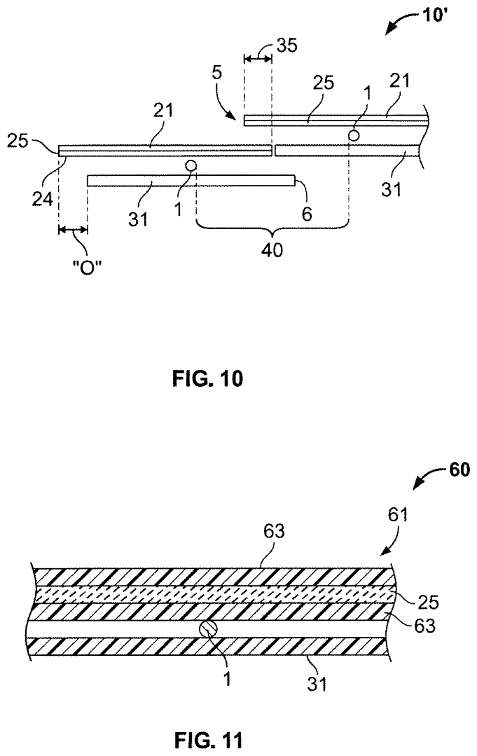

FIG. 10 shows a schematic illustration similar to FIG. 6A but for the embodiment of FIG. 7. That is, the flame resistant barrier material 25 is positioned between the helical wire 1 and film 21 and the helical wire 1 is positioned between the film 31 and the flame resistant barrier material 25. The same offset “O” is employed, the same section 40 is employed for weight bearing and the same overlap 35 exists for the flame resistant barrier material. In this embodiment, the flame resistant barrier material 25 matches the width of the film 21 and the material 25, film 21, and film 31 would be adhered using one or more adhesives. An adhesive could be applied to the surface 24 of the flame-resistant barrier material so as to adhere the film 31, the flame resistant barrier material 25 and film 21 together.

While this embodiment has the flame resistant barrier film 25 match the width of the film 21, the flame resistant barrier film could have a width as shown in FIG. 3A such that the flame resistant barrier material would not reach to the overlap 5. With a narrower width flame resistant barrier material, the offset “O” may have to be larger to ensure that there is overlap of the flame resistant barrier material at the overlap section 35 so that flame penetration testing would not be compromised by the duct wall being only the two polymer films in portions thereof.

Since this embodiment does not employ an additional laminated construction like that shown in FIG. 2, but still employs two films and a helical wire similar to prior art flexible duct constructions, the duct 10′ could be made in a similar fashion, wherein a strip of the film 21, a strip of the flame-resistant barrier material 25, and the helical wire 1 are wound on a mandrel with the appropriate adhesive. This embodiment of the invention offers an advantage in manufacturing in that there is no need for an additional laminating step, whether the laminating is done prior to duct making or as a part thereof. However, since the integration of the flame resistant barrier material is done as part of the duct making, care must be taken in terms of the joining of the flame resistant barrier material between the two films, especially at the overlap where the ends of the films overlap and the flame resistant barrier material is interposed between the two films in the overlap area.

The embodiment of FIG. 10 also applies to the single laminate film, wherein the flame resistant barrier material 25 is first adhered to the film 21 to create the single film laminate 50 and this laminate is then adhered to the helical wire and the film 31.

Another embodiment of the invention is the laminates themselves, which are used to make the flexible duct 10. A preferred embodiment of this aspect of the invention is the two film laminate 20 or single film laminate 50 that are made as a master roll that can generate a plurality of narrower two film laminate rolls, each roll having edges that are slit or cut from the master roll. As noted above, using a higher strength adhesive, e.g., a urethane, is believed to present a solid bonding or joining between the films 21 and 23 and the flame-resistant barrier material across the width of a two film laminate master roll or between the film 21 and the flame resistant barrier material 25 as a single film master roll. With this increased bonding across the width of the master roll, the integrity of bond between the films and the flame resistant barrier material is maintained even after a cutting or slitting of the master roll into segments of desired width. The slit edges produced from the master roll would be different from the edges of the master roll. The joining of the flame resistant barrier material at the edges of the master roll, when made, would involve a free longitudinal edge of the flame resistant barrier material that would be adhered to the two polymer films in the two film laminate or the single polymer film in the single film laminate. In interior portions of the master roll, no free edges of the flame resistant barrier material exist during the adhering of the layers together. Thus, the bond between the layers in the interior portion of the master roll would be stronger as no edge would be present. As between the two kinds of laminates, the single film laminate in a master roll is preferred as it is simpler in construction as compared to the two film laminate so that the duct manufacture is more economical.

The invention also entails a method of use of the inventive flexible duct. The flexible duct can be used in any application where a UL 181 Class 1 rated air duct could be used. Applications can include using the duct to supply conditioned or unconditioned air in residences, commercial buildings and the like. More particularly, the flexible duct could be used in walls, ceiling, floors, and the like.

The invention also provides a method of making the flexible ducts described above as an improvement over the conventional process of making a flexible uninsulated duct by winding a pair of polymer films with a helical wire disposed therebetween, the pair of polymer films joined using an adhesive. In one mode of this improvement, the inventive single laminate 50 or the two film laminate 20 is used as one of the polymer films during the duct making process. In another mode of improvement over the conventional method, the flame resistant barrier material is disposed between one of the polymer films and the helical wire and adhered in place using an adhesive during the winding process.

Another embodiment of the invention is a flexible uninsulated duct that meets Underwriter Laboratories (UL) 181 Class 1 air duct standard and is of slightly different construction as compared to those discussed above. In this embodiment, the flexible uninsulated duct includes a coated flame-resistant barrier material, a polymer film, and a helical wire. The coating of the coated flame-resistant barrier limits vapor and moisture permeability while enhancing surface properties that promote adhesion. The coated flame-resistant barrier material, the polymer film and the helical wire attached together using an adhesive or combination thereof form the duct wall of the flexible duct, the flame-resistant barrier material providing flame penetration and puncture resistance such that the flexible uninsulated air duct meets the UL 181 Class 1 air duct standard.

The helical wire is disposed between the coated flame-resistant barrier material and the polymer film with either the coated flame-resistant barrier material forming the inside wall of the duct and the polymer forming the outside surface of the duct or vice-versa.

FIG. 11 shows a schematic illustration of a portion of a duct wall, the duct designated by the reference numeral 60 for this embodiment, wherein the coated flame resistant barrier material is designated as reference numeral 61. With this construction, the coating 63 could be the inner wall of the duct or the outer wall. The flame resistant barrier material 25 has a coating 63 surrounding it, with the helical wire 1 disposed between one side of the coated flame resistant barrier material 61 and the film 31. While not shown, an adhesive or adhesives as used with embodiments described above, e.g., the embodiment using the double film laminate or the embodiment using the flame resistant barrier layer in combination with one polymer film as one part of the duct wall, could be employed between the flame resistant barrier material and the film 31 to adhere each together with the helical wire 1 disposed therebetween. The coating can be any kind that would withstand any of the requirements imposed in the testing under the UL 181 aid duct standard. While the coating 63 is shown on either side of the flame resistant barrier material 25, the coating 63 could be formed on just one side of the flame resistant barrier material 25.

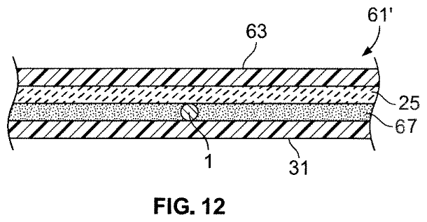

Having the coating on only one side of the flame resistant barrier material 25 is advantageous in that the adhesive or adhesives that would be employed to adhere the coated flame resistant barrier material to the helical wire and polymer film is in contact with the uncoated side of the flame resistant barrier material as shown in FIG. 12. In this Figure, the duct construction is similar to that shown in FIG. 11 and is designated by the reference numeral 61′. The flame resistant barrier material 25 has a coating 63 on just the one side and an adhesive designated by the reference numeral 67 is positioned between the uncoated surface of the flame resistant barrier material 25 and the polymer film 31, the helical wire 1 disposed between the flame resistant barrier material 25 and polymer film 31 as well. Referring back to FIG. 6B and considering the flame resistant barrier material to be designated by reference numeral 20, the overlap portions of the flame resistant barrier material have uncoated to coated surface contact, but it is believed that a sufficiently strong bond can be obtained in this overlap region in spite of the coating on one surface of the flame resistant barrier material given the forces applied during the spiral winding process of making the duct. It is also believed that a sufficiently strong bond can be obtained if the flame resistant barrier material is coated on both sides. A preferred embodiment of the invention is to have the flame resistant barrier material coated on both sides as the coating more completely engages the flame resistant barrier material, especially if the flame resistant barrier material is a woven material as the coating is able to penetrate the material and fill gaps therein and contribute to the advantages of the coating as detailed below.

Another advantage of having the coating on the flame resistant barrier material rather than just adhering an uncoated flame resistant barrier material to the polymer film 31 is that the coating maintains the integrity of the flame resistant barrier material when it is a woven type. The yarns that are typically used to make these flame resistant barrier materials can be somewhat slippery or slick. As a result, the yarns of the woven material can shift or become displaced when the flame resistant barrier material is being spirally wound for duct construction and this yarn movement can disrupt or even cause a termination of the duct manufacturing process. The coating also assists in maintaining the integrity of the manufactured duct by keeping the woven construction of the flame resistant barrier material in place once the duct is manufactured.

The coating on the flame resistant barrier material is also advantageous in that it imparts some additional stiffness to the flame resistant barrier material. Uncoated flame resistant barrier material can be loose or floppy in nature and having the additional layer of coating material on a surface of the flame resistant barrier material improves the handling qualities of the flame resistant barrier material when being made into a duct.

It should be understood that the coated flame resistant barrier material 61 can be used in the duct construction in the same manner as the two film laminate or the single film laminate in terms of being adhered to the film 31 and helical wire 1 when making the flexible air duct. More particularly, the coated flame resistant barrier material can be used in a similar manner as the double film laminate in the winding process for making a spiral wound duct, that is, the coated flame resistant barrier material is in combination with the polymer film, helical wire, and adhesive(s) to adhere the flame resistant barrier material, helical wire, and polymer film together to make the inventive duct.

In terms of the coating material used on the flame resistant barrier material, examples of coating materials include that used to make the S-TL duct mentioned above, which is a polyvinyl chloride material. Acrylic water-based coatings and urethane-based coatings are also candidates for coating the flame resistant barrier material. The example of an acrylic water-based coating for the flame resistant barrier material is similar to the kinds of adhesives used to make conventional spiral wound flexible duct using polymer films and a helical wire, just that the coating used with the inventive duct is not formulated with the pressure sensitive adhesive quality that are found in the adhesives used when making spiral wound ducts. Basically, there is no need for a pressure sensitive adhesive when applying the coating to the flame resistant barrier material and applying the coating is not involved in the duct making winding process.

It is also preferred that the coating include fire retardants as a part thereof. Coating materials containing fire retardant materials are well known in the art. Having the fire retardants in the coating is advantageous in that it minimizes the chance of the coating igniting due to high temperatures that may be encountered in UL 181 Class 1 duct testing, for example, the flame penetration test.

The manner of coating these kinds of flame resistant barrier materials is well known, e.g., dip or spray coatings, and any known methods can be employed, so that a further description of the way the coating is applied to the flame resistant barrier material is not needed for understanding of this aspect of the invention.

Since the inventive flexible insulated duct meets the UL 181 Class 1 air duct standard, it can have a length greater than 14 feet so as not to be considered a connector that falls under this standard as such a connector does not meet all of the tests required for a duct falling under the UL 181 Class 1 duct standard.

For purposes of the invention, uninsulated means that the inventive duct does not use any insulating material surrounding the outer layer of the flexible duct. While the flame resistant barrier material as part of one of the embodiments of the invention disclosed above, e.g., two film laminate, the single polymer film embodiment, or the coated flame resistant barrier material may technically have some finite insulating value, the duct is effectively one that is non-insulating as there is no other insulating material associated with the duct. The insulating value of the flame resistant barrier material is negligible such that a duct that is solely made up of the polymer core and the flame resistant barrier material is effectively one that does not provide an effective insulating value and does not employ any additional insulation on the exterior of the duct. In other words, the outer surface of the duct, regardless of the material of the outer surface, e.g., the polymer film alone, the polymer film in combination with the flame resistant barrier material, or the coated flame resistant barrier material, is an exposed outer surface.

As such, an invention has been disclosed in terms of preferred embodiments thereof which fulfills each and every one of the objects of the present invention as set forth above and provides a new and improved Class 1 rated flexible duct and a method of use.

Of course, various changes, modifications and alterations from the teachings of the present invention may be contemplated by those skilled in the art without departing from the intended spirit and scope thereof. It is intended that the present invention only be limited by the terms of the appended claims.

1. A flexible uninsulated air duct that meets Underwriter Laboratories (UL) 181 Class 1 air duct standard comprising:
a coated flame resistant barrier material,
a polymer film, and
a helical wire disposed between the coated flame resistant barrier material and the polymer film, the coated flame resistant barrier material, polymer film, and helical wire attached together to form a duct wall of the flexible duct, the flexible uninsulated air duct meeting the testing requirements set forth in the UL 181 Class 1 air duct standard.

2. The flexible uninsulated air duct of claim 1, wherein the polymer film is made of polyethylene terephthalate.

3. The flexible uninsulated air duct of claim 2, wherein the coated flame resistant barrier material is either an outer layer or an inner layer of the flexible uninsulated duct.

4. The flexible uninsulated air duct of claim 1, wherein the flame resistant barrier material comprises a flame resistant barrier material selected from the group of a fiberglass-containing woven or nonwoven fabric material and a flame resistant fleece, the flame resistant fleece including flame resistant staple fibers and, optionally, char scaffold fibers.

5. The flexible uninsulated air duct of claim 1, wherein the flame resistant barrier materialis coated on both sides thereof.

6. The flexible uninsulated air duct of claim 1, wherein the adhesive is a water based acrylic adhesive, preferably containing one or more fire retardants.

7. A flexible uninsulated air duct that meets Underwriter Laboratories (UL) 181 Class 1 air duct standard comprising:
a first polymer film,
a second polymer film,
a flame resistant barrier material, and
a helical wire,
the helical wire disposed between the one of the first and second polymer films and the flame-resistant barrier material, the first and second polymer films, the helical wire, and the flame-resistant barrier material attached together using at least one adhesive to form a duct wall of the flexible duct, the flexible uninsulated air duct meeting the testing requirements set forth in the UL 181 Class 1 air duct standard.

8. The flexible uninsulated air duct of claim 7, wherein the first and second polymer films are made of polyethylene terephthalate.

9. The flexible uninsulated air duct of claim 7, wherein the helical wire is between an inside surface of the duct and the flame resistant barrier material or the flame resistant barrier material is between an inside surface of the duct and the helical wire.

10. The flexible uninsulated air duct of claim 7, wherein the adhesive is an anaerobic adhesive such as a water based pressure sensitive adhesive, an acrylic-based adhesive, or a urethane-based adhesive.

11. The flexible uninsulated air duct of claim 7, wherein the flame-resistant barrier material comprises a flame resistant barrier material selected from the group of a fiberglass-containing woven or nonwoven fabric material and a flame resistant fleece, the flame resistant fleece including flame resistant staple fibers and, optionally, char scaffold fibers.

12. The flexible uninsulated air duct of claim 7, wherein one of the first and second polymer films are attached to the flame resistant barrier material using another adhesive to form a single film laminate, and the single film laminate, the helical wire, and the other of the first and second polymer films being attached together using the at least one adhesive to form the duct wall of the flexible duct.

13. The flexible uninsulated air duct of claim 12, wherein one of the first and second polymer films that is part of the single film laminate is perforated.

14. In a method of moving conditioned or unconditioned air through a flexible uninsulated air duct in an interior space of a structure, wherein the flexible uninsulated duct meets the UL 181 Class 1 air duct standard, the improvement comprising providing one or more of the flexible uninsulated air duct of claim 1 in the interior space.

15. The method of claim 14, wherein the one or more flexible uninsulated air duct is positioned in a wall or floor space as the interior space in the structure.

16. A flexible uninsulated air duct that meets Underwriter Laboratories (UL) 181 Class 1 air duct standard comprising:
a two film laminate,
a polymer film, and
a helical wire disposed between the two film laminate and the polymer film, the two film laminate, polymer film, and helical wire attached together to form a duct wall of the flexible duct,
the two film laminate further comprising first and second polymer films, a flame-resistant barrier material positioned between the first and second polymer films, and an adhesive to join the first and second polymer films and flame-resistant barrier material together, the flexible uninsulated air duct meeting the testing requirements set forth in the UL 181 Class 1 air duct standard.

17. The flexible uninsulated air duct of claim 16, wherein the polymer film and first and second polymer films of the laminated layer are made of polyethylene terephthalate.

18. The flexible uninsulated air duct of claim 16, wherein the two film laminate is either an outer layer or an inner layer of the flexible uninsulated duct.

19. The flexible uninsulated air duct of claim 16, wherein the adhesive is an anaerobic adhesive such as a water based pressure sensitive adhesive, an acrylic-based adhesive, or a urethane-based adhesive.

20. The flexible uninsulated air duct of claim 16, wherein the flame resistant barrier material comprises a flame resistant barrier material selected from the group of a fiberglass-containing woven or nonwoven fabric material and a flame resistant fleece, the flame resistant fleece including flame resistant staple fibers and, optionally, char scaffold fibers.

21. The flexible uninsulated air duct of claim 16, wherein the flame resistant barrier material of the two film laminate has opposing longitudinal edges and the opposing longitudinal edges are aligned with or spaced inwardly of longitudinal edges of the first and second polymer films.

22. The flexible uninsulated air duct of claim 16, wherein at least one of the first and second polymer films is perforated.

23. The flexible uninsulated air duct of claim 16, wherein the helical wire, two film laminate, and polymer film are attached together using another adhesive.

24. In a method of moving conditioned or unconditioned air through a flexible uninsulated air duct in an interior space of a structure, wherein the flexible uninsulated duct meets the UL 181 Class 1 air duct standard, the improvement comprising providing one or more of the flexible uninsulated air duct of claim 16 the interior space.

25. The method of claim 24, wherein the one or more flexible uninsulated air duct is positioned in a wall or floor space as the interior space in the structure.

26. A laminated film for use in a flexible uninsulated air duct comprising:
either first and second polymer films; or
a first polymer film;
a flame resistant barrier material positioned between either the first and second polymer films or adjacent to the first polymer film; and
either an adhesive to join either the first and second polymer films and flame resistant barrier material together; or
an adhesive to join the first polymer film and the flame resistant barrier material together.

27. The laminated film of claim 26, wherein the first and second polymer films are made of polyethylene terephthalate.

28. The laminated film of claim 26, wherein the adhesive is an anaerobic adhesive such as a water based pressure sensitive adhesive, an acrylic-based adhesive, or a urethane-based adhesive.

29. The laminated film of claim 26, wherein the flame resistant barrier material comprises a flame resistant barrier material selected from the group of a fiberglass-containing woven or nonwoven fabric material and a flame resistant fleece, the flame resistant fleece including flame resistant staple fibers and, optionally, char scaffold fibers.

30. The laminated film of claim 26, wherein the laminated film has longitudinal edges that are slit from a laminated film of greater width than the laminated film.

31. In a method of making a flexible uninsulated duct by winding first and second polymer films and a helical wire disposed therebetween and applying an adhesive onto one or both of the polymer films to join the first and second polymer films and helical wire to make a duct wall, the improvement comprising using the laminated film of claim 26 as either the first or second polymer film such that the flexible uninsulated air duct meets the testing requirements set forth in the UL 181 Class 1 air duct standard.

32. In a method of making a flexible uninsulated duct by winding first and second polymer films and a helical wire disposed therebetween and applying an adhesive onto one or both of the polymer films to join the first and second polymer films and helical wire to make a duct wall, the improvement comprising disposing a flame resistant barrier material between one of the first and second polymer films and helical wire using the adhesive to form the flexible uninsulated duct, the flexible uninsulated air duct meeting the testing requirements set forth in the UL 181 Class 1 air duct standard.

33. A method of making a flexible uninsulated duct by winding a coated flame resistant barrier layer, a polymer film, and a helical wire disposed therebetween and applying an adhesive between at least the flame resistant barrier layer and the polymer film, such that the flexible uninsulated air duct meets the testing requirements set forth in the UL 181 Class 1 air duct standard.

34. The method of claim 31, wherein the helical wire is between an inside surface of the duct and the flame resistant barrier material or the flame resistant barrier material is between an inside surface of the duct and the helical wire.
